(19) United States
(12) Patent Application Publication
(10) Pub. No.: US 2010/0260476 A1
(43) Pub. Date: Oct. 14, 2010

(54) METHOD AND APPARATUS FOR SECURE CONFIGURATION OF ELECTRONIC DEVICES

(76) Inventors: John F. CLOUTMAN, Tracy, CA (US); Ronald QUAN, Cupertino, CA (US)

Correspondence Address: MORRISON & FOERSTER LLP, 755 PAGE MILL RD, PALO ALTO, CA, 94304-1018, US

(21) Appl. No.: 12/422,751

(22) Filed: Apr. 13, 2009

(51) Int. Cl. H04N 5/91; H04N 5/14; H03M 1/12; G06F 21/00

(52) U.S. Cl. 386/94; 348/571; 348/572; 726/26; 348/E05.062

(57) ABSTRACT

Method and apparatus for ensuring the security of configuration or programming data supplied to an electronic device, such as a video consumer electronic device. This is achieved by storing within an integrated circuit video processor in the device both logic and data for checking the security of input configuration and/or programming data for the video processor to detect and prevent tampering with same. Not only is it determined if the input data is correct versus unacceptable, also if it is determined unacceptable, the logic then determines if the input data is the result of an innocent error or tampering by a hacker and takes appropriate protective steps accordingly.

### FIELD OF THE INVENTION

This invention relates to electronic devices such as consumer electronic devices and especially to the security of such devices in terms of their programming and other configuration data.

### BACKGROUND

Many electronic devices include a programmable or configurable aspect by which a user or other person can program the device to operate in certain ways. This “programming” is also referred to as supplying configuration data. An example of such a device is a cable or satellite television set top box (STB) which includes certain security aspects such as video content copy protection. The copy protection is embodied in electronic circuits in the set top box and controls the nature of the video output from the set top box to prevent copying thereof. Such set top boxes include various control and setting registers (memory locations) which control and adjust the application of the copy protection process and a conventional video encoder circuit. Typically, the register bits or configuration data are programmable within a range beyond that which is actually practical in the sense of actually defining a useful output. Thus these bits can be misprogrammed intentionally or otherwise.

The present inventors have identified a flaw with this approach in that hackers, that is unauthorized users who wish to tamper with the set top box, may be able to tamper with the register settings and thus force the device to allow copying when it should not be permitted. Current set top boxes are believed to be quite vulnerable to such tampering by hackers in spite of existing security systems. Therefore there is need to improve security systems of such set top boxes and similar electronic devices but not limited to consumer electronic devices. For instance many commercial or industrial electronic devices may included such programmability which the manufacturer or distributor may wish to control to prevent users from tampering therewith.

### SUMMARY

This disclosure is directed to improvements in the security of an electronic device, such as a consumer electronics device including a video processor typically on an integrated circuit. As pointed out above, typically various register bits (values) which define aspects of operation of such a device are programmable within a range beyond which may be practical or useful and which may be intentionally, maliciously or even innocently misprogrammed. In accordance with the invention, a table of default values for these register bits is provided in a secure memory associated with the electronic device and logically acted upon to inhibit the writing to the registers (memory locations) to any state other than an approved value or range of values. Moreover, the device may respond in a particular way to attempts to write the registers to non-default values, thus defeating attempts by a hacker to tamper with the device. In one embodiment, optimum values for each register bit are set during manufacturing and the device is fabricated with those values included in an internal secure read only memory (ROM) table of settings, but this is not limiting. Once installed in the device, the table of optimum values in memory cannot be changed by a user or hacker.

Also disclosed here is a configuration for such electronic devices by which content control security is provided in an electronic “system on a chip”, which is generally a well known type of integrated circuit, to prevent reprogramming or substitution of memory devices containing the operating system or configuration data or any other alterations of the content control security. The security logic may act such that attempted tampering, when detected, renders the entire device useless, temporarily or permanently.

In one embodiment, the present method and apparatus improve security of various copy control and setting registers in the system on a chip in a consumer electronic device, for instance a cable or satellite television set top box. The data in these registers controls and adjusts the application of, for instance, the well-known commercially available Macrovision Corp. analog video copy protection processes (“ACP”) which include one or more video signals (waveforms) from the group of: pseudo-sync and/or automatic gain control signal(s), back porch pulse, (blanking) level shift, and/or color stripe burst provided by a video encoder integrated circuit in the set top box. In this embodiment, a table of default values of the register settings (configuration data) is provided in the memory of the system on a chip and is used in accordance with the content control security logic to inhibit writing into these registers configuration data to any state other than that in the approved range or an approved value. The ranges of values for each register are determined during, for instance, device manufacture and typically the system on a chip stores in its read-only memory an internal table of such register values. In one embodiment, the entire table of default values for the registers for copy protection may be apparatus specific, with the content control security logic applied to prohibit use of any impractical or erroneous (whether intentional or unintentional) register settings thus preventing hacking and also preventing input of innocent data errors due to electronic or human error. This improves security and prevents errors caused by both innocent misprogramming and hacking and thereby improves the copy protection effectiveness.

This security logic may be used on its own or in conjunction with other “trigger bits” in the data stream, which may be designated to or interpreted as invoking content rights management or protection. These are conventionally called “APS trigger Bits” where APS refers to the Analog Protection System. The APS is used in a DVD copy prevention system also known as ACP, originally developed by Macrovision Corp. In DVD discs, trigger bits are created during DVD authoring to inform a DVD player that the Copy Protection Process should be applied to its analog video outputs. In set top boxes, trigger bits are incorporated into Conditional Access Entitlement Control Messages (ECM) in the stream delivered to the STB. In VHS video tape recording, alterations to the analog video signal are added in a Macrovision Corp.-provided “processor box” used by tape duplicators. There are trigger bits designated in MPEG-2 transport streams, but not all MPEG transmission methods or protocols use the same bits or locations in the stream. An example is the IEEE-1394 interface where APS trigger bits were not designated in the same locations as for MPEG-2 in a DVD transport stream. ATSC HDTV (high definition television) also has bits designated for possible future use as copy protection trigger bits.

### BRIEF DESCRIPTION OF THE FIGURES

FIG. 1 shows in a block diagram relevant portions of a typical prior art consumer or other electronics apparatus.

FIG. 2A shows an embodiment of the invention.

FIG. 2B shows another embodiment.

FIG. 3A shows another embodiment.

FIG. 3B shows detail of the embodiment of FIG. 3A.

### DETAILED DESCRIPTION

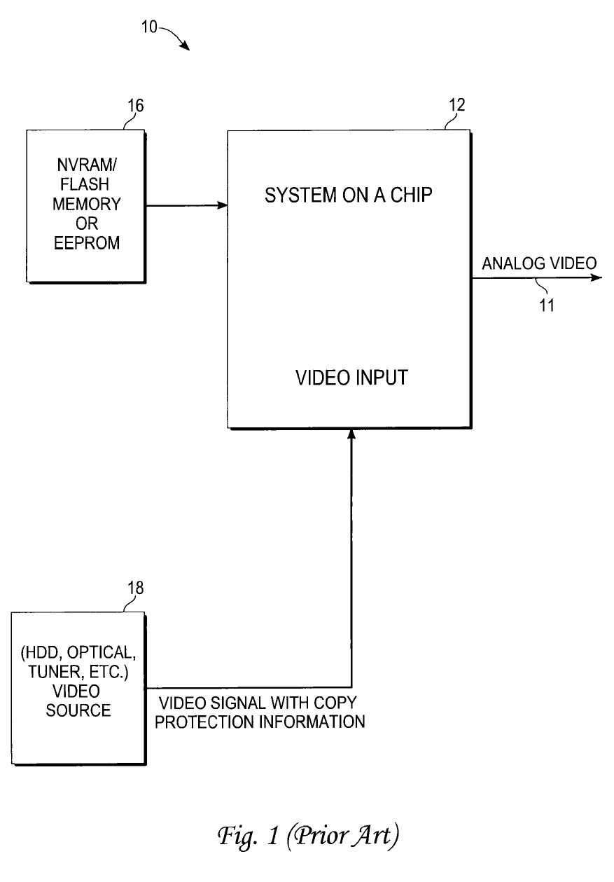

Prior art FIG. 1 shows in a block diagram relevant portions of a typical conventional consumer electronics apparatus 10 such as a cable television/satellite television set top box. The chief element is a “system on a chip” 12 also called “SOC”, which conventionally includes a microprocessor and other associated circuitry and is an integrated circuit (“chip”) of a type available commercially. Associated with this and on a separate chip 16 is a non-volatile random access memory (NVRAM) or flash memory or EEPROM (electrically erasable programmable read only memory) which is a memory device (an integrated circuit here) and stores as data the controller software and operating system software and data for the apparatus 10 including any content control system. This is embodied in software or firmware typically in the form of compiled object code or binary data stored in memory device 16 and provided when needed to the microprocessor portion of the system on a chip (SOC) 12.

Device 10 receives from an external video source 18 such as a recording medium drive or player (e.g., a DVD drive or hard disk drive or optical disk drive) or a television tuner, a digital video signal that includes copy protection information, usually in the form of one or more bit patterns. The SOC 12, using the software/firmware provided by memory device 16, converts this digital video to analog form by its internal video processor and outputs the analog video at output port 11 with some suitable type of copy protection, as indicated by the input video and/or copy protection information bit pattern data from video source 18, to a video output device such as a television set (not shown). In this case, the content control software or firmware and/or data stored in memory 16 is relatively easily tampered with by a hacker who reprograms memory device 16 or substitutes a new memory device 16. Hence in the prior art approach, the relevant programming information is stored in the system RAM or ROM at memory 16 along with the content control logic which acts effectively as the operating system for the SOC 12. This programming information includes for instance copy control register setting data. The registers in the SOC 12 that store the data from memory element 16 are writable and thus memory element 16 can be interfered with or re-written by direct communication with system on a chip 12 via a common and well known interface such as 12C. Hence, a hacker for instance could reprogram the system on a chip 12 by temporarily connecting a computer to the communication interface for system on a chip 12, or by merely replacing the entire memory element 16 (usually an integrated circuit). As pointed out above, such tampering with the relatively insecure memory 16 allows for instance, a digital video signal with copy protection information that would normally generate a command to provide one or more copy protection waveforms or content control signals at the analog output, to instead provide a copyable analog video signal.

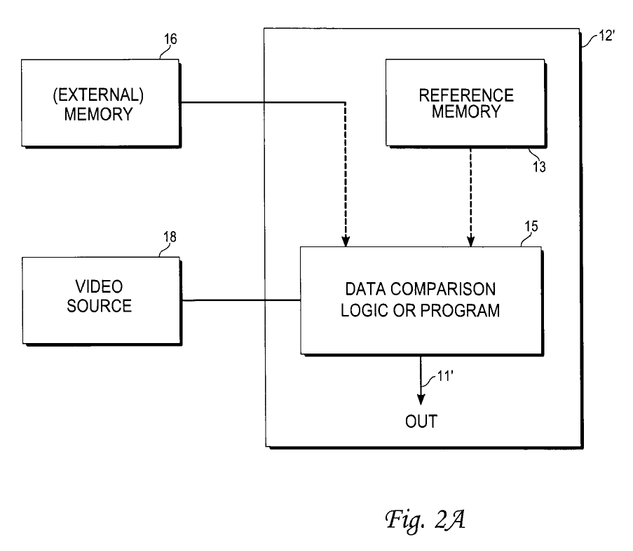

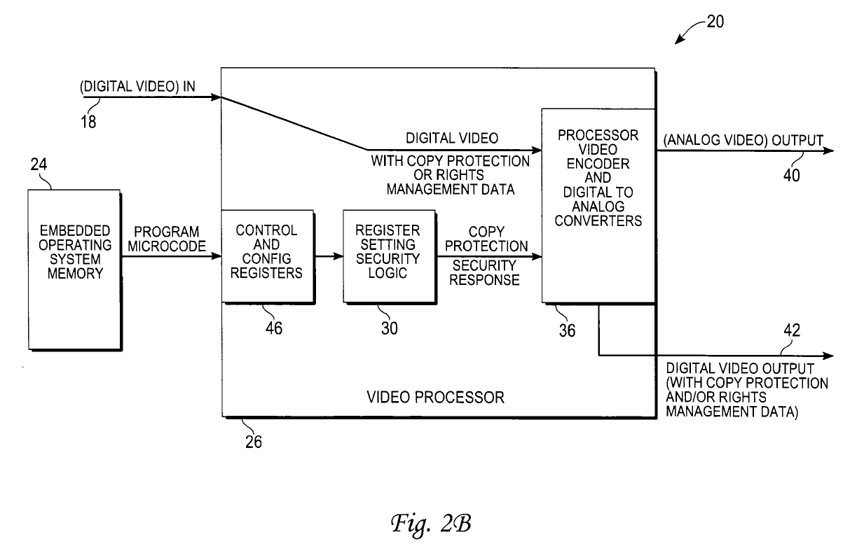

FIG. 2A shows an embodiment of the invention based on the FIG. 1 apparatus. A modified version of the SOC is chip 12′. Memory element 16 (e.g., internal or external memory or storage) again stores data to program a content control or copy protection signal, and video source 18 is the same or similar as in FIG. 1. In SOC 12′ there is at least one added element or feature compared to SOC 12. A first added element is a reference memory data or reference storage register 13 used to store data to be compared to the data supplied from (external) memory 16. A second added element is a data comparison logic device or program 15 (executed on a suitable processor in SOC 12′) to perform the comparison. Should the data from memory 16 be found to be correct in the comparison, a proper signal modification (e.g., adding a copy protection or content control signal) via logic 15 to the output video signal on port 11′ is implemented. When comparing the data between the reference memory 13 with that from memory 16, a binary bit pattern is output by logic 15. This binary bit pattern may as simply represent a high or low state, or is a quantitative value. The quantitative value is in a range of numbers. A third added feature is that logic 15 interprets the quantitative value as a correct match to the content of memory 16, an innocent error from memory 16, or a hacking attempt from memory 16 and acts accordingly.

In one example, the comparison between data from memory 13 and memory 16 is when both data match, or equivalently, a subtraction of the data bits between those stored in memories 13 and 16 is zero. When the data matches, one example of the result is to provide the analog video output 11′ with the correct ACP modification. E.g., reference memory 13 stores configuration data that includes programming bits for a “correct” copy protection signal such as line and pixel locations, including amplitude of AGC pulses, back porch pulses, pseudo sync pulses, color burst modifications, color stripe envelopes, partial or split color stripe signal, level shifting, and/or sync modification). A correct modification may include known application of well-known video copy protection or content control signals such as pseudo sync pulses, AGC pulses, color burst modifications, offsets in a portion of one or more TV lines, and/or the like. However, should there be a mismatch between the reference data from memory 13 and the memory data from memory 16, the video output at port 11′ may instead have added to it a known “default” waveform such as a preprogrammed copy protection or content control waveform. Alternatively, an out of range (e.g., gross) mismatch in data (which can be construed as a hacking attempt on memory 16) can result in provision of a degraded video signal at video output 11′. Thus, a fourth added feature includes providing a modified or detrimental effect on the program video upon the detection or determination of a hacking attempt (e.g., an out of range set of bit(s), or added waveform locations, pixel level(s), amplitude, pulsewidth, phase, etc., which would be beyond a predetermined tolerance).

Thus SOC 12′ performs qualitative interpretation comparing data from reference memory 13 and memory 16. For example, this comparing can include a simple subtraction circuit or program. Normally the difference between the data stored in memories 13 and 16 should be zero, but in the case of hacking or an innocent programming error on memory 16, the difference between the data will be nonzero. How far away the non zero (value) difference is from zero can then (qualitatively) determine or formulate whether the non zero difference is deemed an innocent error or a hacking attempt. For example, an innocent error may be construed as being a small non-zero difference value. Thus for instance, when an innocent error is determined or evaluated by a small non-zero different value, the video output 11 can be modified to include a default copy protection/content control waveform.

Alternatively, if hacking of memory 16 is attempted, then most likely the non zero difference value is greater. Chip 12′ then takes this non-zero difference value and provides (depending on the non-zero value, varying degrees of) a suitable modification to the video output at port 11′ such as a substituted video waveform, blanking signal, and/or degraded signal.

In general a logical comparison or arithmetic comparison between the data of reference memory 13 and memory 16 will provide a measured response within chip 12′. This measured response can range from providing a correct copy protection/content control signal to providing a modified video signal output that is degraded or a video signal output that includes copy protection/content control signal. Logic 15 (which may be implemented in a suitably programmed processor) then may include a program and/or circuit for a logical or arithmetic function based on reference data from memory 13 and data from memory 16. Logic 15 may include circuitry or a program to interpret data from memories 13 and 16 to provide a measured response or a security response. To provide a modified video signal, logic 15 includes a digital to analog converter and circuitry including logic to generate or otherwise provide the programmable waveforms such as pseudo sync pulses, AGC pulses, or provide level shifting in selected pixels and lines, or provide color burst modifications.

FIG. 2B shows in a more detailed block diagram relevant portions of a consumer electronics or similar device 20 also in accordance with the invention, which is similarly coupled as in FIG. 2A to source 18 that includes copy protection or content control information in the form of one or more bit pattern. In this case, the (external) memory device 24 (same as memory 16 in FIG. 2A) stores the controller and operating system software (or data) including the content control or copy protection configuration setting data and/or security software and/or logic. For example, the configuration setting data includes data for selecting one or more waveforms at the video output port 40. The reference content control/copy protection configuration settings are stored as shown in register setting control and configuration registers 46 in the video processor SOC (integrated circuit) 26. (SOC 26 here is somewhat similar to SOC 12′ in FIG. 2B.) Registers 46 include e.g., factory programmed read only memory (ROM). Register setting security logic 30 includes content control security logic or software. One or more reference control and configuration registers in ROM 46 may for example, include the Macrovision Corp. copy control registers per Table 1 as described below.

Reference data stored in control and configuration registers 46 is used to evaluate, e.g. by comparison, copy control and configuration settings input from (external) memory 24. One or two of these registers are process control registers, and the remainder is process-setting registers that finely adjust some of the copy protection waveform parameters. For example, the control registers include bits for enabling or disabling one or more content control and/or copy protection waveforms. The control registers data bits turn on or off at least one of the following as described above: pseudo sync pulses, back porch pulses, AGC pulses, level shifting a portion of the (analog) video signal, color burst modification, sync amplitude reduction, pulsation mode for AGC pulses, color stripe, and partial color stripe. The configuration (settings) data or bits allow for providing parameters pertaining to line location, pixel location, pulse width, pulse amplitude, pulsation rate, pulse frequency, pulse spacing for pseudo syncs, AGC pulses, and/or back porch pulses. For color burst modifications, the configuration (settings) data allow for providing phase shift angle, pixel locations, lines locations, number of segments in the modified color stripe signal (see U.S. Pat. No. 6,516,132 issued to Wrobleski and Quan), duration of the modified color burst (including a wider than normal duration color burst), added cycles prior and/or after a normal color burst's location, number of added cycles of normal and/or non-normal phase color subcarrier in providing the modified color burst signal to a video signal.

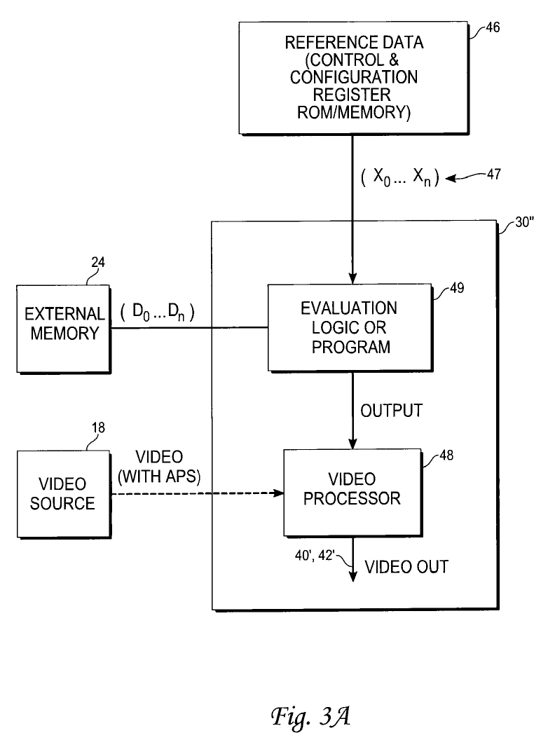

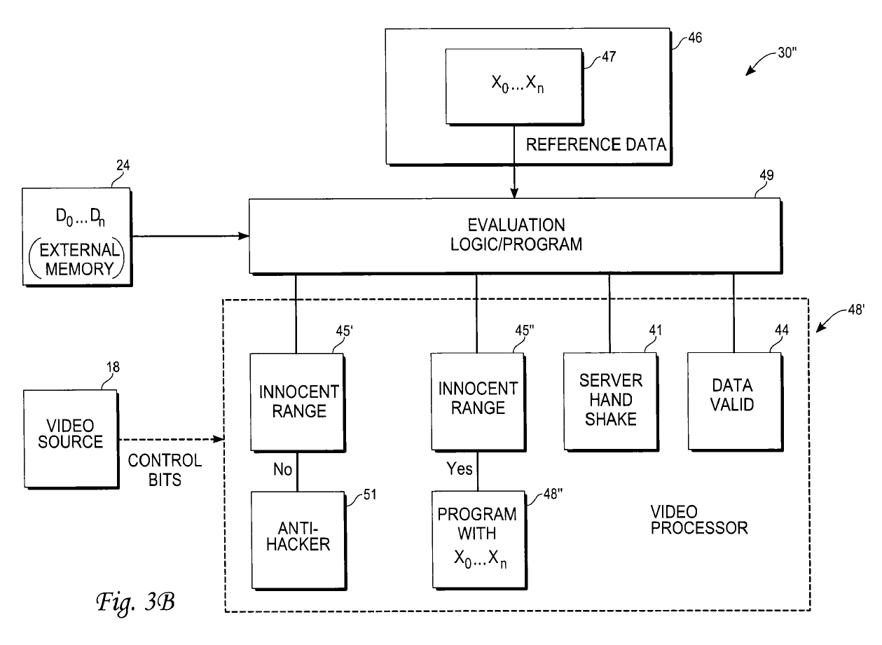

In one embodiment as explained above the present system compares the content of a reference memory containing control and/or configuration data or registers to that of another (external) memory device/circuit so as to confirm whether one or more copy protection waveforms are enabled and/or disabled correctly. Another embodiment confirms by comparing contents of the reference memory and external memory that a copy protection waveform is configured properly in terms of line location, pixel location, duration, frequency, phase, amplitude, pulsation amplitude and frequency, spacing between added pulses, or the like. Security logic 30 is typically a processing circuit or software or firmware executed on a microprocessor (and/or a sub-processor) in SOC 26 and conventionally includes logic and memory and is dedicated to checking the state (content) of the reference data from registers 46 and/or from memory 24 and/or from video source 18, and for example, logically determining a response as explained (below) with reference to FIG. 3B.

This arrangement enhances the security of device 20 by making it relatively difficult or impossible to reprogram the security logic 30. Substitution of a new memory device 24 would have either a negative effect (such as causing implementation of anti-hacking measures e.g., a detrimental effect on the program video signal or adding-inserting a copy protection/control control waveform for the analog output) or no effect on the security logic software or firmware or memory contents of security logic 30 here, dependent upon the control and configuration values contained in the substituted memory device 24.

Also shown in FIG. 2B as part of SOC 26 is a conventional video encoder portion (processor) 36 with its associated digital to analog converter which outputs copy protected analog video at port 40 and digital video at port 42. Control and configuration registers 46 perform the function of storing a set of reference data indicating, e.g., if and how to configure any or all aspects of the video copy protection process to be applied in the analog video output at encoder 36, or other action to be taken by SOC 26. This data is checked and acted upon by security logic 30 before being sent to video encoder 36 or other portions of SOC 26.

FIG. 3A shows a block diagram of relevant portions only of yet another embodiment. The external video source 18 includes in its output video APS (or control) bits as explained above. Reference data memory 46 as in FIG. 2B stores a reference bit pattern (data) Xo to Xn, 47. Security logic 30″ is similar to security logic 30 in FIG. 2B. External or other data memory 24, which may store correct data or incorrect (hacked) data, is coupled to an evaluative logic circuit or a program 49 executed by a processor in logic 30″. Reference data 47 is also coupled to logic 49. Logic 49 outputs a signal that indicates how many digits of reference data 47 are correct, or outputs a signal indicative of how close the reference data 47 and external (or other) data from memory 24 are. A command is generated by video processor 48 based on the value or signal received from logic 49. For example, video processor 48 will process the incoming video signal based on the output of logic 49. If there is an exact match of reference to external data, then the correct or standard waveform(s) will be provided at the video output port 40′ or 42′ of video processor 48. The APS or other control bit pattern memory in the incoming video from source 18 would then select one or more such waveforms based on content of a media player or control bit(s) from a digital delivery network (not shown).

If the data from memory 24 is a mismatch with reference data 47, the evaluation logic (or program) 49 outputs a signal indicating quantitatively how far off is the mismatch. This signal is similarly coupled to video processor 48, which takes one or more actions. For example, if the mismatch in data is deemed small, this can be deemed as an innocent error, and video processor 48 may output a standard video waveform or a default video waveform at port 40′ or 42′ (e.g., the video waveform would include at least part of a copy protection waveform or a content control waveform).

However, if the output of logic 49 is indicative of a greater than small mismatch between data 47 and the data from memory 24, then video processor 48 may output a number of video waveforms at port 42′ or 40′ such as a default copy protection/content control signal, a shut-down of the video output, a degraded video signal, or a substituted signal. Any of these waveforms may be provided upon indication of a greater than a small mismatch or in combination with the APS or other control bit(s) in the incoming video signal from source 18.

FIG. 3B shows more detail of the FIG. 3A system. The logic embodied in video processor 48′ defines four possible scenarios (conditions) based on comparing the reference data 47 stored in memory 46 with an external device or (other) data from memory 24. FIG. 3B thereby illustrates one or more examples of decision making or outcomes based on evaluation program or logic 49. Security logic element 30″ is in one embodiment intended to prevent hacking, that is malicious tampering. This is shown in FIG. 3B, which shows the logic carried out by the software or firmware of security logic 30″. Such firmware is re-programmable but not as easily re-programmed as the firmware in an external flash memory type device. Security logic 30″ is, e.g. a microprocessor, akin to but more programmable than a state machine. As shown here, registers (memory) 46 (also shown in FIG. 3A) output the received programming/configuration data to the evaluation logic 49 within security logic element 30″ of a system on a chip (the remainder of which is not shown in FIG. 3B for simplicity). Evaluation logic 49 then arithmetically compares configuration data from (external) memory 24 with reference configuration data 47 from register memory 46. An exemplary comparison function may include using the logic XOR function, which outputs a High or True when there is dissimilarity between two inputs. The XOR (with inverted or non-inverted output) may check or compare each bit. A tabulation of how many mismatched bits can then be used for an evaluation such as innocent error (small number of mismatches) or non-innocent error (number of mismatches beyond a set or programmed number).

The normal operating mode consists of comparing configuration data 47 from registers 46 and data from (external) memory 24 by evaluation logic 49, the result of that procedure then indicating to allow video content to be played with or without the indicated level of copy protection such as applied at logic step 44 by video processor 48′. For example, with an exact match of reference data 47 and (external) data 24, a bit pattern of APS or other control bit(s) from the video source 18 will determine various levels of copy protection signals, such as AGC pulses, AGC pulses and a first color stripe signal, or AGC pulses and a second color stripe signal.

However, in some cases there may be a problem detected with the programming/configuration data, which is detected here at logic steps 45′ or 45″ of the security logic 30″. If the data from other or external memory 24 does not exactly match the reference data in registers 46 then the type of data mismatch is checked at steps 45′ or 45″. If the mismatch is deemed “innocent” at step 45″ as explained above then configuration data 47 is used and logic element 30″ controls video processor 48′ as to how to proceed at step 48″, e.g., apply a certain type of copy protection/content control waveform to the output video. Typically, this “innocent” error range would be a range of settings which is not useful or has no particular meaning e.g., due to an error in programming, either human or otherwise. However if the answer to the question “Is this an innocent mismatch/error?” is “no” at step 45′, that is the programming data is erroneous but not within an “innocent error” range, this data (from memory 24) is determined to be a malicious penetration attempt by a hacker. For example, at step 51 suitable antihacking steps are taken, as set forth in further detail below. A last logical step 41 in FIG. 3B designated “server handshake” means that if the external data is a match, processor 30″ communicates with a (video) server to allow further storage or other activity involving the output video.

With reference to FIG. 3B, the various antihacker logic steps at step 51 may be any which defeat or discourage hacking, for instance unauthorized reprogramming to defeat copy protection or content control signal(s). Examples of antihacker steps/measures/actions/implementations are providing an error message to the user, resetting the device to some default set of programming data, disabling the video output completely in the case of a device such as a media player, receiver, recorder, and/or set top box, provision of a (color bar) test pattern or other non-standard (TV signal), changing the video standard to another TV standard, changing the resolution, changing the audio signal (e.g., lower quality audio), non-usable signal as a video output or perhaps just shutting down the device completely. In the extreme example, detection of a hacked input is used to permanently disable all or part of the electronic device, but of course this is extreme. This would be done e.g., by causing the parent device to go into a “reset loop” (for example, so it could not ever start running again, a kind of auto-destruct mode. The goal is to punish or discourage the hacker.

Note that what is referred to above as a “system on a chip” need not be a true system on a chip, but instead may be merely a reduced instruction set computer chip (RISC) or Advanced RISC microcomputer (ARM) integrated circuit configured by external instructions or data such as microcode provided from (external) memory 24 and/or also having external clock devices and an external controller (not shown). Such a system on a chip may have limited on-chip random access memory and read-only memory, only enough in this example to store the content control security data at registers 46.

Table 1 below shows for the above-described Macrovision Corp. analog video copy protection processes a set of exemplary register 46 settings (data) intended for a typical television set top box 20. This might include a typical Macrovision Corp. set of register settings, which would be stored in registers 46 as configuration data as explained above for configuring a copy protection scheme. (This data in the prior art FIG. 1 is stored in external memory 24.) The present embodiments provide added security for the data and thus the copy protection processes it controls and configures. Combined with the security logic element, this is much more secure. This table is intended for use (with a Macrovision Corp. enabled integrated circuit) for copy control as implemented by the SOC 26 in FIG. 2B.

TABLE 1

| D2 | D1 | D0 | X2 | X1 | X0 | Result | Innocent | Anti-Hacker |
|---|---|---|---|---|---|---|---|---|
| 0 | 0 | 0 | 0 | 0 | 0 | No ACP | 0 | 0 |
| 0 | 0 | 0 | 0 | 0 | 1 | ACP Type 1 | 1 = YES | 0 |
| 0 | 0 | 1 | 0 | 0 | 1 | ACP Type 1 | 0 | 0 |
| 1 | 0 | 0 | 0 | 1 | 0 | ACP Type 2 | 1 = YES | 0 |
| 1 | 1 | 0 | 0 | 1 | 1 | Malicious | 0 | 1 = YES |
| | | | | | | Hack attempt | | |
| 1 | 0 | 0 | 1 | 0 | 0 | Other - Private | 0 | 0 |
| 1 | 1 | 1 | 1 | 1 | 1 | Other - Private | 0 | 0 |
| 0 | 0 | 1 | 0 | 0 | 0 | No ACP | 0 | 0 |
| 0 | 0 | 1 | 0 | 0 | 1 | ACP Type 1 | 0 | 0 |
| 0 | 1 | 0 | 0 | 1 | 0 | ACP Type 2 | 0 | 0 |
| 0 | 1 | 1 | 0 | 1 | 1 | ACP Type 3 | 0 | 0 |

All the above value ranges or default correct settings are stored for reference in the memory 46 of the security logic in the system on a chip video processor (e.g., SOC 26 of FIG. 2B). They can be arithmetically compared with the data supplied by the operating system firmware (stored in (external) memory 24), and logically operated on by the security logic in the event there is a discrepancy between what is sent from outside and what is stored internally in ROM 47 of the security logic by the system on a chip 26.

As an example of how the present copy control logic operates, it typically perform conditional checks as shown in FIG. 3A or 3B in logic 49 at steps 44, 45′, 45″ applied to the Table 1 data using the Table 1 logic. Typically these checks are applied on a field-by-field (or bit-by-bit) basis to the data shown in Table 1. For instance, one possible check (Table 1, 5th row) checks if a specific type of mismatch exists between reference data field X0 . . . X2 and external or other data field D0 . . . D2 and if so, then the video output is effectively disabled and/or an error is reported. In other examples of conditional checks (Table 1, rows 10 and 11) if a specific match exists between field X0 . . . X2 and field D0 . . . D2 then take some action such as applying a certain type of copy protection waveform to the video output. Logic element 30″ would act on specific data matches and/or mismatches by indicating specific responses by SOC 26. The purpose of this is to ensure proper enablement and/or disablement and/or configuration of the ACP processes using the detection and reporting of circumventional (hacking) attempts, and prohibition of the hacker's attempt to obtain illegitimate user rights assignments to the output video.

In other embodiments, the evaluation logic 49 may command SOC 26 (that is, video processor 48 or 48′) to encrypt, decrypt, encode or decode private video, audio or data both in the analog and digital domains. This private video, audio or data could for example be located in a multiplexed transport stream on a DVD or other media. For example, private video audio or data is extracted from the video source 18 by SOC 26 upon reading of a certain data value in a specific packet of data in the transport stream and matching it with settings, check sum of values or aggregate bit values from locations in registers 46 within SOC 26.

In another example, registers 46 may contain a pointer to the location of the private data in the transport stream. The private data in the transport stream may comprise a special or non-standard copy protection waveform to be applied at the video output, for example. Some settings of reference control bits 47 from chip 26, when input to the security logic at registers 46 may cause the reference configuration data 47 to be used in performing e.g., a “secret handshake” between chip 26 and the operating system firmware stored in memory 24, or between chip 26 and video source 18. Chip 26 processes video normally unless it is configured and/or receives the secret handshake code, then it, e.g., encrypts, encodes, decrypts or decodes the outgoing or incoming video, audio or data. The secret handshake could, e.g., be used to display a decrypted secret program in the form of video, audio or data, or to configure and apply a special waveform to the output video. Certain specific pieces of media may be created which contain unique private information. Once decrypted or decoded, the private video, audio or data could be stored and/or displayed as indicated by the settings in reference registers 46. This way, e.g., an ordinary-looking DVD player could be used (with specific playback media and code) to pass sensitive information securely.

Implementation of the hardware (circuitry) and software and firmware (computer code) described here would be routine to those skilled in the art in light of this disclosure. Suitable languages for the software for the logic in the various embodiments are C, BASIC, MATLAB, PERL, PYTHON, RUBY, or machine code. Instead of computer code, hardware logic may be used in whole or in part. The computer code, in source code or more likely compiled (object code) form, is typically stored in a computer readable medium such as factory installed ROM (read only memory) in the security logic.

In an alternative embodiment to the evaluative process whether the data mismatch between reference data and external data (e.g., from external memory 24) is within an innocent error range or not, an actual comparison of video copy protection waveform parameter(s) may be used. For example, a copy protection process may include any combination of waveform(s) such as AGC pulses, pseudo sync pulses, sync modifications, back porch modification, or color burst modification. In any of these waveforms, there are parameters that set the duration, amplitude, line location(s), repetition rate, position, number or pulses per line, phase, and/or pixel location(s). Therefore, a particular (external) memory such as memory 24 may store data that is not an exact match to the reference data. This mismatch in the data in memory 24 then provides to any of the waveforms a deviation, Δx in the duration, amplitude, line location(s), repetition rate, position, phase, level (shifting), and/or pixel location(s) from the waveform(s) that would be provided by the reference data. Thus, an innocent error may tabulate or correlate the Δx for each waveform. A Δx beyond the range for a particular waveform may be construed as a hacking attack, or a Δx within the range for a particular waveform may be deemed an innocent error. For example, if the reference data calls for an AGC pulse width to be 2.3 μsecs, and the other or external memory data calls for an AGC pulse width to be 2.2, μsecs, then this (small or within a range) mismatch can be construed as an innocent error. However, if the other or external memory data calls for the AGC pulse width to be less than or equal to 0.6 μsec, then there is a large or out of range mismatch, and it would appear the AGC pulse is being deleted or defeated or reduced in effectiveness (e.g., by narrowing); and thus, a hacking attempt may be interpreted.

One or more security features of the system then prevents hacking of the other or external data from: circumventing or reducing and effect of a content control or copy protection signal intended to be provided in a video signal, providing a more effective content control or copy protection waveform (e.g., add more AGC, pseudo sync, and/or color burst modifications), providing a reduced playability content control or copy protection waveform, providing an improved playability content control or copy protection waveform, or providing any unauthorized waveform (e.g., a content control or copy protection waveform from another company or standard).

This description is illustrative and not limiting. Although the above explanation is largely in the context of video copy protection, this is not limiting and electronic devices subject to the present method and apparatus need not be a set top box or similar device and need not be for or employ video or other copy protection or content control. Hence modifications and improvements which will be apparent to those skilled in the art in light of this disclosure are intended to fall within the scope of the invention as defined by the appended claims.

I claim:

1. An integrated circuit video processor device comprising:
a port for receiving data;
a memory coupled to the port and adapted to store configuration data received via the port;
a video processor; and
a security logic portion coupled to the memory and to the video processor to receive the configuration data from the memory, and which determines if the received configuration data is within a predetermined range usable by the video processor.

2. The device of claim 1, wherein the security logic portion includes memory which stores predetermined configuration data defining the range, and the security logic portion compares the stored predetermined configuration data to the received configuration data.

3. The device of claim 1, wherein the video processor is coupled to receive digital video data and convert the digital video data to analog video.

4. The device of claim 3, wherein the video processor applies one or more copy protection signals to the analog video in accordance with the received configuration data.

5. The device of claim 1, wherein the received configuration data configures output of the video processor if within the predetermined range.

6. The device of claim 1, wherein if the received configuration data is outside the predetermined range, the security logic portion determines if the received configuration data is within a second predetermined range, and if not re-requests the external configuration data.

7. The device of claim 6, wherein if the configuration data is within the second predetermined range, the security logic portion applies an anti-hack measure.

8. The device of claim 7, wherein the anti-hack measure is selected from the group consisting of:
providing an error indication;
providing to the processor default configuration data;
providing to the processor an instruction to output a predetermined output;
disabling an output of the processor;
shutting down the device; and/or
disabling the device.

9. The device of claim 1, wherein the security logic portion executes a set of computer code instructions.

10. The device of claim 4, wherein the copy protection signals includes one or more signals from the group consisting of: color stripe, pseudo-sync and/or automatic gain control, back porch pulse, blanking level shift, and/or color stripe burst.

11. The device of claim 10, wherein the configuration data also specifies a television standard for the copy protection signals.

12. The device of claim 2, wherein the security logic portion memory is read only memory (ROM).

13. A computer readable medium storing the set of computer code instructions of claim 9.

14. A method of operating an integrated circuit having a video processor and adapted to receive external configuration data, processing the configuration data, and configuring the output of the video processor, the method comprising the acts of:
receiving the configuration data from an external source;
determining if the received configuration data is within a predetermined range by comparison with a set of values stored in the integrated circuit; and
configuring an output of the video processor according to the configuration data only if the configuration data is within the predetermined range.

15. The method of claim 21, wherein the stored values define the range, and the act of determining compares the stored values to the received configuration data.

16. The method of claim 21, wherein the video processor is coupled to receive digital video data and convert the digital video data to analog video.

17. The method of claim 23, wherein the video processor applies copy protection signals to the analog video in accordance with the received configuration data.

18. The method of claim 21, wherein the received configuration data configures output of the video processor if within the predetermined range.

19. The method of claim 21, wherein if the received configuration data is outside the predetermined range, the act of determining determines if the received configuration data is within a second predetermined range, and if not re-requests the external configuration data.

20. The method of claim 26, wherein if the configuration data is within the second predetermined range, further comprising applying an anti-hack measure.

21. The method of claim 27, wherein the anti-hack measure is selected from the group consisting of:
providing an error indication;
providing to the processor default configuration data;
providing to the processor an instruction to output a predetermined output;
disabling an output of the processor;
shutting down the device; and/or
disabling the device.

22. The method of claim 21, wherein the method includes executing a set of computer code instructions.

23. The method of claim 24, wherein the copy protection signals includes one or more signals from the group consisting of: color stripe, pseudo-sync and/or automatic gain control, back porch pulse, blanking level shift, and/or color stripe burst.

24. The method of claim 30, wherein the configuration data also specifies a television standard for the copy protection signals.

25. The method of claim 14, wherein the set of values are stored in read only memory.
